(19) United States
(12) Patent Application Publication
(10) Pub. No.: US 2007/0159057 A1
(43) Pub. Date: Jul. 12, 2007

(54) Image Display Device

(76) Inventors: Yoshiyuki Kaneko, Hachioji (JP); Yuuichi Kijima, Chosei (JP); Shigemi Hirasawa, Chiba (JP); Kenji Kato, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/620,121

(22) Filed: Jan. 5, 2007

(30) Foreign Application Priority Data
Jan. 6, 2006 (JP) 2006-001110

(51) Int. Cl. H01J 63/04; H01J 1/62; H01J 19/42

(52) U.S. Cl. 313/495; 313/292

(57) ABSTRACT

In an image display device, end surfaces of spacers are jointed to substrates in a state that the spacers bite into a conductive adhesive material 13 in the depth direction of a coating thickness of the conductive adhesive material. Due to such a constitution, it is possible to provide the image display device which possesses high brightness, high reliability and a prolonged lifetime by suppressing the breakage and the deformation of distance holding members which hold a distance of a hermetically sealed space surrounded by a face substrate, a back substrate and a frame body.

### BACKGROUND OF THE INVENTION

1. Field of the Invention

The present invention relates to a planar image display device which makes use of emission of electrons into vacuum formed between a face substrate and a back substrate, and more particularly to an image display device which arranges a plurality of space holding members between the face substrate and the back substrate.

2. Description of the Related Art

A color cathode ray tube has been popularly used conventionally as an excellent display device which exhibits high luminance and high definition. However, along with the realization of high image quality of recent information processing device and television broadcasting, there has been a strong demand for a planar image display device (a flat panel display: FPD) which is light-weighted and requires a small space for installation while ensuring the excellent properties such as high luminance and high definition.

As typical examples of such a planar image display device, a liquid crystal display device, a plasma display device or the like has been put into practice. Further, particularly with respect to the planar image display device which can realize the high brightness, various types of planar image display devices such as a self-luminous display device (for example, a so-called electron emission type image display device, a field emission type image display device or the like) which makes use of emission of electrons into vacuum from electron sources, an organic EL display which is characterized by low power consumption are also expected to be put into practice in near future.

Among these planar image display devices, with respect to the self-luminous flat panel display, there has been known a display device having the constitution in which electron sources are arranged in a matrix array, wherein as one such display, there has been also known the above-mentioned field emission type image display device (FED: Field Emission Display) which makes use of minute and integrative cold cathodes.

In the self-luminous flat panel display, as cold cathodes, electron sources of a Spindt type, a surface conduction type, a carbon nanotubes type, an MIM (Metal-Insulator-Metal) type which laminates a metal layer, an insulator and a metal layer, an MIS (Metal-Insulator-Semiconductor) type which laminates a metal layer, an insulator and a semiconductor layer, a metal-insulator-semiconductor layer-metal or the like has been used.

As the planar image display device, there has been known a display panel which includes a back substrate having the above-mentioned electron sources, a face substrate which includes phosphor layers and anodes which form accelerating electrodes for allowing electrons emitted from the electron sources to impinge on the phosphor layers and is arranged to face the back substrate, and a sealing frame body for sealing an inner space formed by opposing surfaces of both substrates into a given vacuum state. The planar image display device is operated in a state that drive circuits are combined with the display panel.

The image display device having the MIM type electron sources includes a back substrate which forms, a large number of first lines (for example, cathode lines, image signal lines) which extend in the first direction and are arranged in parallel in the second direction which intersects the first direction, an insulation film which is formed in a state that the insulation film covers the first lines, a large number of second lines (for example, gate lines, scanning signal lines) which extend in the second direction and are arranged in parallel in the first direction over the insulation film, and electron sources which are provided in the vicinities of intersecting portions of the first lines and the second lines. The back substrate is made of an insulating material and the above-mentioned lines are formed on the substrate.

In such a constitution, a scanning signal is sequentially applied to the scanning signal lines in the second direction. Further, on the substrate, the electron sources which are connected to the scanning signal lines and the image signal lines are provided, and an electric current is supplied to the electron sources using a power supply electrode. The face substrate which faces the back substrate in an opposed manner includes phosphor layers of plural colors and an anode. The face substrate is made of a light-transmitting material which is preferably made of glass. Further, a space defined between both substrates is sealed by arranging the sealing frame body between both substrates, and the inside which is formed by the back substrate, the face substrate and the support body is evacuated and hence, an image display device is constituted.

The electron source is positioned at the intersecting portion of the first line and the second line as mentioned above. An emission quantity of electrons from the electron source (including the turning on and off of the emission) is controlled based on a potential difference between the first electrode which is connected to the first line and the second electrode which is connected to the second line. The emitted electrons are accelerated due to a high voltage applied to the anode formed on the face substrate, and impinge on phosphor layers formed on the face substrate. Accordingly, the phosphors are excited by the electrons and generate colors.

The individual electron source forms a pair with the corresponding phosphor layer so as to constitute a unit pixel. Usually, one pixel (color pixel) is constituted of the unit pixels of three colors consisting of red (R), green (G) and blue (B). Here, in case of color pixels, the unit pixels which constitute the respective colors are also referred to as sub pixels.

In the planner image display device described above, in general, in the inside of a space which is arranged between the back substrate and the face substrate and is surrounded by the frame body, a plurality of distance holding members (hereinafter referred to as spacers) is arranged and fixed. The distance between the above-mentioned both substrates is held at a predetermined distance in cooperation with the frame body. The spacers are formed of a plate-like body which is made of an insulating material such as glass, ceramics or the like, in general. The spacers are arranged at positions which do not impede an operation of pixels.

Further, the sealing frame body is arranged between the back substrate and the face substrate and is fixed to the back substrate and the face substrate using a sealing material. The sealing frame body defines a hermetically sealed space together with the back substrate and the face substrate. The degree of vacuum in the inside of the hermetically sealed space defined by both substrates and the support body is set to 10⁻³ to 10⁻⁶ Pa, for example.

First line lead terminals which are connected to the first lines formed on the back substrate and second line lead terminals which are connected to the second lines formed on the back substrate penetrate the sealing regions defined by the frame body and both substrates. Usually, the sealing frame body is fixed to the back substrate and the face substrate using the sealing material such as frit glass or the like. The first line lead terminals and the second line lead terminals are pulled out through a sealing region which constitutes the hermetic sealing portion defined by the sealing frame and the back substrate.

Further, in the planner image display device, when the spacer is brought into contact with the respective substrates, the spacer is electrically and mechanically fixed to the substrates using conductive glass flit. The above-mentioned technique is disclosed in Japanese patent No. 3554312 (patent document 1), wherein the spacer is fixed by adhesion to the substrates by merely applying the heat treatment after applying the conductive glass flit thereon.

### SUMMARY OF THE INVENTION

The FPD includes the frame body which forms a hermetically sealed space between opposedly facing portions of both substrates, and a plurality of spacers which is arranged in the inside of the hermetically sealed space surrounded by the frame body. The spacers are, for example, arranged in parallel to scanning signal lines in the inside of the hermetically sealed space. In such an arrangement of the spacer, the spacer has upper and lower ends thereof fixed to the substrates using an adhesive material. In fixing the spacer, a thickness of an adhesion layer is changed when the adhesive material is softened or is reheated. This change of the thickness of the adhesion layer makes the fixing of the spacer and the ensuring of a distance between both substrates difficult. This tendency is observed particularly with respect to the face substrate side compared to the back substrate side.

When the spacer cannot be fixed to the substrates, there exists a possibility that the spacer is inclined or broken. Further, the inability to ensure a predetermined size as the distance between both substrates generates the deformation of the substrate attributed to an atmospheric pressure and, at the same time, hampers an evacuation operation thus making the evacuation under a high vacuum impossible. Accordingly, there arises a drawback that both of brightness and lifetime are deteriorated and hence, an image display device with high reliability cannot be obtained.

The present invention has been made to overcome such a drawback and, it is an object of the present invention to provide an image display device which can obtain high brightness, high reliability and a prolonged lifetime by suppressing the breakage and the deformation of spacers which hold a hermetically sealed space surrounded by a face substrate, a back substrate and a frame body.

To achieve the above-mentioned object, an image display device according to the present invention includes the following constitution. The image display device according to the present invention includes a face substrate which forms phosphor layers and an anode electrode on an inner surface thereof, a back substrate which forms electron sources on an inner surface thereof and faces the face substrate in an opposed manner with a predetermined distance therebetween, a frame body which is interposed between the face substrate and the back substrate and is arranged so as to surround an image display region, and holds the predetermined distance between the substrates, a plurality of distance holding members which is arranged in the inside of a hermetically sealed space which is arranged between the face substrate and the back substrate, and a conductive adhesive material which fixes by adhesion end surfaces of the distance holding members with the face substrate and the back substrate respectively. The end surfaces of the frame body, the face substrate and the back substrate are hermetically sealed to each other by way of a sealing material. The distance holding members are jointed to both substrates in a state that the distance holding members bite into the conductive adhesive material in the depth direction of a coating thickness of the conductive adhesive material and hence, at adhesion surfaces of the distance holding members with the face substrate and the back substrate, the distance holding members are electrically and mechanically firmly joined to the substrates. Due to such a constitution, the present invention can overcome the drawbacks of the related art.

Further, in another image display device according to the present invention, the back substrate includes a plurality of scanning signal lines which extend in one direction, are arranged in parallel in another direction which intersects one direction, and to which scanning signals are sequentially applied in another direction, a plurality of image signal lines which extend in another direction and are arranged in parallel in one direction so as to intersect the scanning signal lines, electron sources which are provided in the vicinities of respective intersecting portions of the scanning signal and the image signal lines, and power supply electrodes which connect the electron sources and the scanning signal lines and the image signal lines respectively. Further, the distance holding members are arranged in a state that the distance holding members are overlapped to the scanning signal lines and extend in the same direction as the scanning signal lines.

Further, another image display device according to the present invention includes a face substrate which forms a black matrix film in which a plurality of opening portions is formed, phosphor layers having a plurality of colors which are arranged in a state that the phosphor layers close the opening portions and extend over the black matrix film, and an anode electrode which is made of a metal thin film and covers the phosphor layers and the black matrix film on an inner surface thereof, a back substrate which forms a plurality of scanning signal lines which extend in one direction, are arranged in parallel in another direction which intersects one direction, and to which scanning signals are sequentially applied in another direction, a plurality of image signal lines which extend in another direction and are arranged in parallel in one direction so as to intersect the scanning signal lines, and electron sources which are provided in the vicinities of respective intersecting portions of the scanning signal lines and the image signal lines on an inner surface thereof, and faces the face substrate in an opposed manner with a predetermined distance therebetween, a frame body which is interposed between the face substrate and the back substrate in a state that the frame body surrounds a display region and holds the predetermined distance, a plurality of distance holding members which are arranged to be overlapped to the scanning signal lines and extend in the same direction with the scanning signal lines between the face substrate and the back substrate and within the display region, and a conductive adhesive material which joins by adhesion end surfaces of the distance holding members to the face substrate and the back substrate respectively. The end surfaces of the frame body and the face substrate and the back substrate are hermetically sealed to each other by way of a sealing material. The distance holding members are jointed to both substrates in a state that the distance holding members bite into the conductive adhesive material in the depth direction of a coating thickness of the conductive adhesive material and hence, at adhesion surfaces of the distance holding members with the face substrate and the back substrate, the distance holding members are electrically and mechanically firmly joined to the substrates. Due to such a constitution, the present invention can overcome the drawbacks of the related art.

Further, in another image display device according to the present invention, in the above-mentioned constitution, a width of the conductive adhesive material may preferably be set larger than a width of the distance holding member.

According to the image display device of the present invention, the distance holding members are jointed to both substrates in a state that the end surfaces of the distance holding members bite into the conductive adhesive material in the depth direction of a coating thickness of the conductive adhesive material and hence, it is possible to firmly ensure the more reliable electric connection and mechanical fixing between the distance holding members and the back substrate as well as between the distance holding members and the face substrate using the distance holding members. Accordingly, it is possible to surely prevent the breakage and the deformation of the distance holding members or the deformation of the substrates or the like attributed to an atmospheric pressure and hence, a high vacuum can be ensured by increasing the evacuation efficiency whereby it is possible to acquire an extremely excellent advantageous effect that an image display device which exhibits a prolonged lifetime, high brightness and high reliability can be obtained.

### BRIEF DESCRIPTION OF THE DRAWINGS

FIG. 1 is a plan view for explaining one embodiment of an image display device according to the present invention as viewed from a face substrate side;

FIG. 2 is a side view as viewed in the I direction in FIG. 1;

FIG. 3 is a schematic plan view of a back substrate shown by removing the face substrate shown in FIG. 1;

FIG. 4 is a schematic cross-sectional enlarged view showing the back substrate taken along a line II-II in FIG. 3 and the face substrate corresponding to the back substrate;

FIG. 5 is an enlarged schematic cross-sectional enlarged view of an essential part of the back substrate taken along a line III-III in FIG. 3;

FIG. 6A, FIG. 6B and FIG. 6C are views for explaining an example of electron sources 10 which constitute pixels of the image display device of the present invention, wherein FIG. 6A is a plan view, FIG. 6B is a cross-sectional view taken along a line A-A′ in FIG. 6A, and FIG. 6C is a cross-sectional view taken along a line B-B′ in FIG. 6A; and

FIG. 7 is a view of an example of an equivalent circuit of the image display device to which the constitution of the present invention is applied.

### DESCRIPTION OF THE PREFERRED EMBODIMENTS

Hereinafter, preferred embodiments of the present invention are explained in detail in conjunction with drawings showing the embodiments.

### Embodiment 1

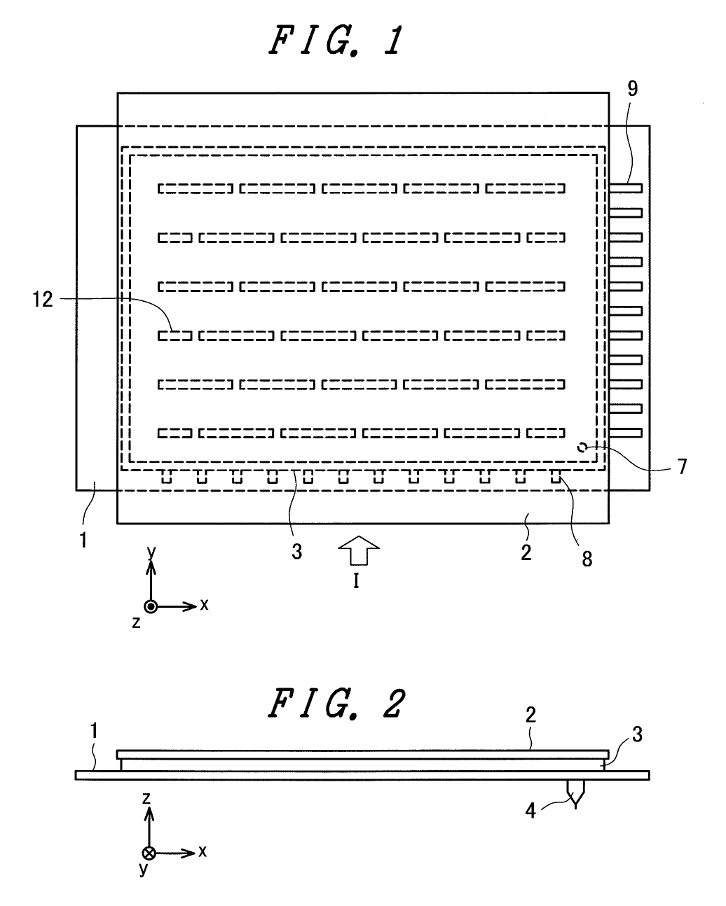

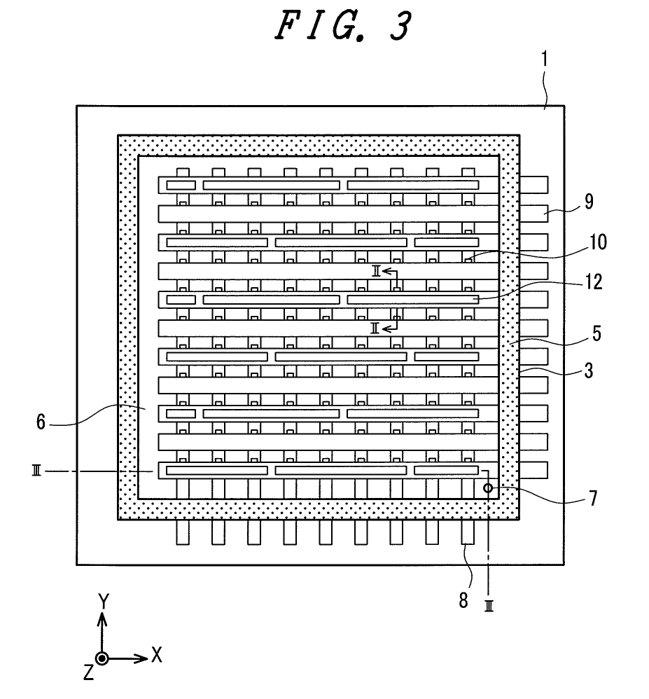

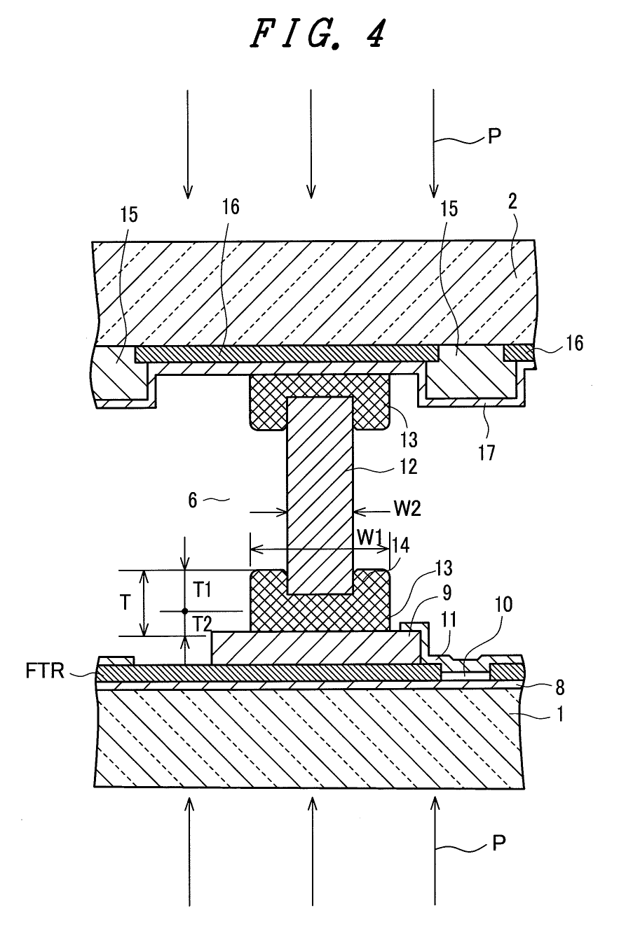

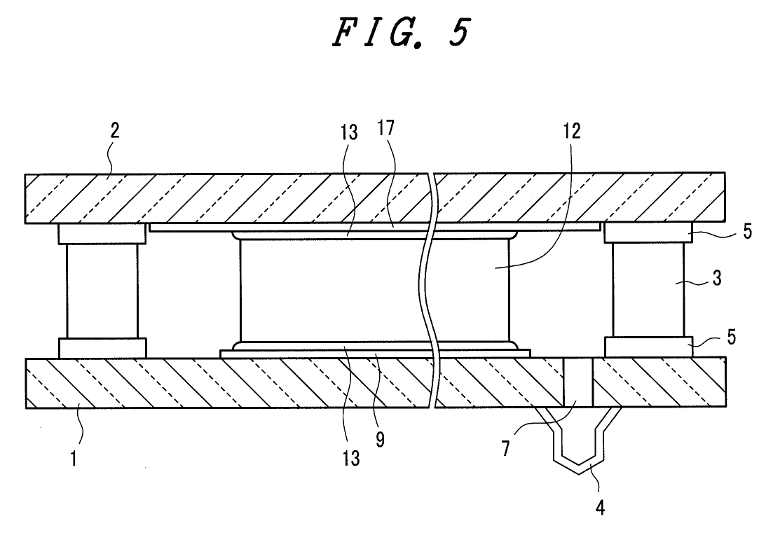

FIG. 1 to FIG. 5 are views for explaining an embodiment 1 of an image display device according to the present invention, wherein FIG. 1 is a plan view as viewed from a face substrate side, FIG. 2 is a side view as viewed in the I direction in FIG. 1, FIG. 3 is a schematic plan view of a back substrate shown by removing the face substrate shown in FIG. 1, and FIG. 4 is a schematic cross-sectional view taken along a line II-II in FIG. 3, and FIG. 5 is a schematic cross-sectional view taken along a line III-III in FIG. 3.

In FIG. 1 to FIG. 5, numeral 1 indicates a back substrate and numeral 2 indicates a face substrate, wherein the back substrate 1 and the face substrate 2 are formed of a glass plate having a thickness of several mm, for example, approximately 3 mm. Numeral 3 indicates a frame body which is formed of a glass plate or a sintered body made of frit glass having a thickness of several mm, for example, approximately 3 mm. Numeral 4 indicates an exhaust pipe which is fixedly secured to the back substrate 1. The frame body 3 is inserted between the back substrate 1 and the face substrate 2, and the frame body 3 is hermetically sealed to the back substrate 1 and the face substrate 2 using a sealing material 5 such as a frit glass, for example.

A hermetically sealed space 6 which is surrounded by the frame body 3, the back substrate 1, the face substrate 2 and the sealing material 5 is evacuated through the exhaust pipe 4 thus holding a degree of vacuum of, for example, 10⁻³ to 10⁻⁶ Pa. Further, the exhaust pipe 4 is mounted on an outer surface of the back substrate 1 and is communicated with a through hole 7 which is formed in the back substrate 1 in a penetrating manner, and after completing the evacuation, the exhaust pipe 4 is sealed. Numeral 8 indicates image signal lines and the image signal lines 8 extend in one direction (Y direction) and are arranged in parallel in another direction (X direction) on an inner surface of the back substrate 1. Further, numeral 9 indicates scanning signal lines, and the scanning signal lines 9 extend over the image signal lines 8 in another direction (X direction) which intersects the image signal lines 8 and are arranged in parallel in one direction (Y direction). The scanning signal lines 9 are arranged closer to a phosphor surface side than the image signal lines 8.

Further, numeral 10 indicates electron sources, wherein the electron sources 10 are formed in the vicinity of respective intersecting portions of the scanning signal lines 9 and the image signal lines 8, and the scanning signal lines 9 and the electron sources 10 are connected with each other by connection electrodes 11. Further, an interlayer insulation film FTR is arranged between the image signal lines 8, the electron sources 10 and the scanning signal lines 9. Here, the image signal lines 8 are formed of an Al/Nd film, for example, while the scanning signal lines 9 are formed of a Cr film, an Al film or a stacked film constituted of the Cr film and the Al film, for example.

Further, numeral 12 indicates distance holding members (hereinafter, referred to as spacers). The spacers 12 are made of a ceramic material and are shaped in a rectangular thin plate shape, for example. In this embodiment, the spacers 12 are arranged upright above the scanning signal lines 9 every other line, and are arranged to the back substrates 1 and the face substrate 2 by way of an adhesive material 13 by fixing. The spacers 12 are usually arranged at positions which do not impede operations of pixels for every plurality of respective pixels.

Sizes of the spacers 12 are set based on sizes of substrates, a height of the frame body 3, materials of the substrates, an arrangement interval of the spacers 12, a material of spacers and the like. In general, the height of the spacers 12 is approximately equal to a height of the frame body 3, a thickness of the spacers 12 is set to several 10 μm to several mm or less, while a length of the spacers 12 is set to approximately 20 mm to 400 mm. Preferably, a practical value of the length of the spacers 12 is approximately 80 mm to 250 mm. Further, the spacers 12 possess a resistance value of approximately 10 to 10⁹ Ω·cm.

Further, the conductive adhesive material 13 constitutes of a vitrification constituent formed of low-melting point flit glass (being mainly constituted of SiO₂, B₂O₃, and PbO, for example) and a conductive constituent (containing approximately 30 wt % to 80 wt % of silver minute particles) having a particle size of several μm to several tens μm (approximately 3 μm to 10 μm, for example) which exhibits the conductivity. Due to the use of the conductive adhesive material 13, both end surfaces of the spacer 12 are fixed by adhesion to the inner wall surfaces of the back substrate 1 and the face substrate 2 in a state that the end surfaces of the spacer 12 bite into the conductive adhesive material 13 in the direction of coating thickness of the conductive adhesive material 13 whereby the spacers 12 are joined to both substrates 1, 2. Accordingly, it is possible to ensure the reliable adhesion fixing strength and electrical connection of the spacers 12 with the back substrate 1 and the face substrate 2.

The conductive adhesive material 13 is formed using a means such as a print coating method and has a resistance value of substantially 1Ω to 100Ω. Although it is recommendable to use silver particles from a viewpoint of easiness of handling and a low manufacturing cost as the conductive constituent of the conductive adhesive material 13, one material selected from a group consisting of gold (Au), nickel (Ni), copper (Cu), platinum (Pt), palladium (Pd) and the like or alloy of these materials may be used in the same manner as the conductive constituent. Further, with respect to the flit glass, a radiation quantity of gas can be reduced using the low melting-point solder glass compared to a case that other frit glass is used. Further, when a thickness of the conductive adhesive material 13 is excessively large, there exists a possibility that the temperature of the conductive adhesive material 13 is elevated and a high voltage irregularly enters the space thus adversely affecting an electron beam trajectory. Accordingly, it is desirable to set the thickness within the above-mentioned range.

Further, a thickness T2 of the adhesion portion of the conductive adhesive material 13 is set to several 10 μm or more, preferably approximately 20 μm to 40 μm from a viewpoint of ensuring the conductivity of the conductive adhesive material 13 with the scanning signal lines 9. A total thickness T of adhesion layers (T1+T2) is preferably set to approximately 50 μm+30 μm to ensure a large tolerances with respect to a height of the spacers 12.

Further, as shown in the drawing, the conductive adhesive material 13 which is applied to the scanning signal lines 9 has a coating width W1 thereof set to a value twice or more as large as a width W2 of the spacer 12. Accordingly, it is possible to compensate for the fragility of the fixing of the spacers 12 attributed to the deformation of the spacers 12 and the misalignment of the substrates.

Further, the conductive adhesive material 13 is, as shown in FIG. 5, formed to cover a whole surface of a proximal portion of the spacer 12 along the whole length of the spacer 12. The conductive adhesive material 13 is arranged on the scanning signal lines 9 in a state that the conductive adhesive material 13 faces the scanning signal lines 9 in an opposed manner thus easily forming a discharge circuit from the face substrate 2 on a high voltage side to the back substrate 1 on a low voltage side. Accordingly, the spacers 12 are hardly charged and hence, a trajectory of electrons is ensured whereby it is possible to make the electrons sufficient for exciting the phosphor impinge on the phosphor screen. As a result, it is possible to enhance the brightness and to display an image with excellent color reproducibility.

Further, the phosphor layers 15 which are arranged on an inner surface of the face substrate 2 include a plurality of phosphors of red, green and blue, and these phosphor layers 15 are arranged in a state that the phosphor layers 15 are defined by a light-blocking BM (black matrix) film 16. Further, a metal back (an anode electrode) 17 made of a metal thin film is formed in a state that the metal back 17 covers the phosphor layers 15 and the BM film 16 by a vapor deposition method, for example, thus forming the phosphor screen. A thickness of the BM film 16 is set to several 100 μm, and a thickness of the metal back 17 is set to several 10 nm to several 100 nm.

Here, with respect to the phosphor layers 15, for example, Y₂O₂S:Eu(P22-R) may be used as the red phosphor, ZnS:Cu,Al(P22-G) may be used as the green phosphor, and ZnS:Ag,Cl(P22-B) may be used as the blue phosphor. In such a phosphor screen constitution, electrons irradiated from the above-mentioned electron source 10 are accelerated and impinge on the phosphor layer 15 which constitutes the corresponding pixel. Accordingly, the phosphor layer 15 emits light of the given color and the light is mixed with an emitted light of color of the phosphor of another pixel thus constituting the color pixel of a given color. Further, although the anode electrode 17 is indicated as a face electrode, the anode electrode 17 may be formed of stripe-like electrodes which are divided for every pixel column while intersecting the scanning signal lines 9.

Next, a manufacturing method of the image display panel having such a constitution is explained.

First of all, the sealing material 5 is applied to an inner peripheral portion of the face substrate 2 which forms the phosphor screen which is constituted of the phosphor patterns of the phosphor layers 15, the BM film 16, the metal back (anode electrode) 17 and the like on a substrate-use glass plate in the X direction as well as in the Y direction, the adhesive material 13 is applied to predetermined portions of an inner surface of the face substrate 2 and, thereafter, the spacers 12 are aligned and are temporarily adhered to the face substrate 2. Next, the sealing material 5 is applied to an inner peripheral portion of the back substrate 1 which forms the plurality of image signal lines 8, scanning signal lines 9 and electron sources 10 on a substrate-use glass plate respectively, and the conductive adhesive material 13 is applied to the predetermined scanning signal lines 9 arranged on an inner surface of the back substrate 1. Next, the face substrate 2 to which the spacers 12 are temporarily adhered, the back substrate 1 to which the sealing material 5 and the adhesive material 13 and the frame body 3 are aligned, assembled and adhered to each other. As shown in FIG. 4, in adhering these parts, a pressure P1 and a pressure P2 are applied from outer surfaces of the back substrate 1 and the face substrate 2 respectively and hence, a substantially uniform pressure is imparted to both substrates in adhering these parts.

According to the above-mentioned adhesion method, the spacers 12 form biting portions which extend in the thickness direction of the adhesive material 13 applied to the back substrate 1 and the face substrate 2 respectively on surfaces thereof which are adhered to the back substrate 1 and the face substrate 2. Due to the formation of the biting portions, it is possible to acquire the reliable electrical connection using the spacers 12 and, at the same time, mechanical fixing of the spacers 12 can be strengthened thus enhancing the reliability of the display panel.

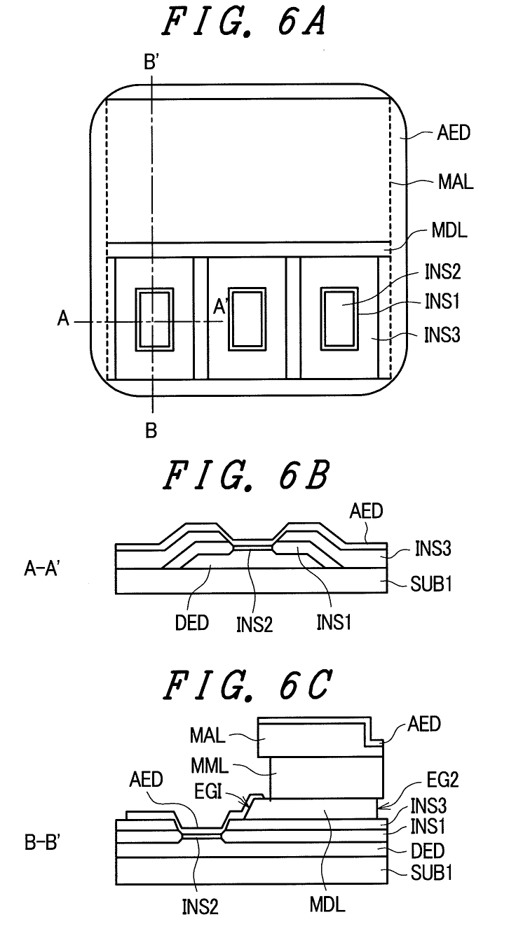

FIG. 6A, FIG. 6B and FIG. 6C are views for explaining an example of electron sources 10 which constitute pixels of the image display device of the present invention, wherein FIG. 6A is a plan view, FIG. 6B is a cross-sectional view taken along a line A-A′ in FIG. 6A, and FIG. 6C is a cross-sectional view taken along a line B-B′ in FIG. 6A. The electrons sources are formed of an MIM type electron source.

The structure of the electron source is explained in conjunction with manufacturing steps thereof. First of all, on the back substrate SUB1, lower electrodes DED (the video signal electrodes in the embodiment), a protective insulation layer INS1, an insulation layer INS2 are formed. Next, an interlayer film INS3, upper bus electrodes (the scanning signal electrodes in the embodiment) which become electricity supply lines to upper electrodes AED, and a metal film which constitutes a spacer electrode for arranging spacers 12 are formed by a sputtering method, for example. Although the lower electrodes and the upper electrodes are made of aluminum, these electrodes may be made of other metal described later.

The interlayer film INS3 may be made of silicon oxide, silicon nitride, silicon or the like, for example. Here, the interlayer film INS3 is made of silicon nitride and has a film thickness of 100 nm. The interlayer film INS3, when a pin hole is formed in a protective insulation layer INS1 formed by anodizing, fills a void and plays a role of ensuring the insulation between a lower electrode DED and an upper bus electrode (a three-layered laminated film which sandwiches copper (Cu) which constitutes a metal film intermediate layer MML between a metal film lower layer MDL and a metal film upper layer MAL) which constitutes a scanning signal electrode.

Here, the upper bus electrode AED which constitutes the scanning signal line is not limited to the above-mentioned three-layer laminated film and the number of layers may be increased more. For example, the metal film lower layer MDL and the metal film upper layer MAL may be made of a metal material having high oxidation resistance such as aluminum (Al), chromium (Cr), tungsten (W), molybdenum (Mo) or the like, an alloy containing such metal, or a laminated film of these metals. Here, the metal film lower layer MDL and the metal film upper layer MAL are made of an alloy of aluminum and neodymium (Al—Nd). Besides the alloy, with the use of a five-layered film in which the metal film lower layer MDL is a laminated film formed of an Al alloy and Cr, W, Mo or the like, the metal film upper layer MAL is a laminated film formed of chromium (Cr), tungsten (W), molybdenum (Mo) or the like and an Al alloy, and films which are brought into contact with the metal film intermediate layer MML made of Cu are made of a high-melting-point metal, in a heating step of a manufacturing process of the image display device, the high-melting-point metal functions as a barrier film thus preventing Al and Cu from being alloyed whereby the five-layered film is particularly effective in the reduction of resistance of wiring.

When the upper bus electrode AED is made of Al—Nd alloy, a film thickness of the Al—Nd alloy in the metal film upper layer MAL is larger than a film thickness of the Al—Nd alloy in the metal film lower layer MDL, and a thickness of Cu of the metal film intermediate layer MML is made as large as possible to reduce the wiring resistance. Here, the film thickness of the metal film lower layer MDL is approximately 300 nm, the film thickness of the metal film intermediate layer MML is approximately 4 μm, and the film thickness of the metal film upper layer MAL is approximately 450 nm. Here, Cu in the metal film intermediate layer MML can be formed by electrolytic plating or the like besides sputtering.

With respect to the above-mentioned five-layered film which uses high-melting-point metal, in the same manner as Cu, it is particularly effective to use a laminated film which sandwiches Cu with Mo which can be etched by wet etching in a mixed aqueous solution of phosphoric acid, acetic acid and nitric acid as the metal film intermediate layer MML. In this case, a film thickness of Mo which sandwiches Cu is set to approximately 50 nm, a film thickness of the Al alloy of the metal film lower layer MDL which sandwiches the metal film intermediate layer MML with the metal film upper layer MAL is approximately 300 nm, and the film thickness of the Al alloy of the metal film upper layer MAL which sandwiches the metal film intermediate layer MML with the metal film lower layer MDL is approximately 450 nm.

Subsequently, the metal film upper layer MAL is formed in a stripe shape which intersects the lower electrode DED by performing the patterning of resist by screen printing and etching. In performing the etching, for example, a mixed aqueous solution of phosphoric acid and acetic acid is used for wet etching. By excluding the nitric acid from the etchant, it is possible to selectively etch only the Al—Nd alloy without etching Cu.

Also in case of the five-layered film which uses Mo, by excluding the nitric acid from the etchant, it is possible to selectively etch only the Al—Nd alloy without etching Mo and Cu. Here, although one metal film upper layer MAL is formed per one pixel, two metal film upper layers MAL may be formed per one pixel.

Subsequently, by using the same resist film directly or using the Al—Nd alloy of the metal film upper layer MAL as a mask, Cu of the metal film intermediate layer MML is etched by wet etching using a mixed aqueous solution of phosphoric acid, acetic acid and nitric acid. Since an etching speed of Cu in the etchant made of mixed aqueous solution of phosphoric acid, acetic acid and nitric acid is sufficiently fast compared to an etching speed of the Al—Nd alloy and hence, it is possible to selectively etch only Cu of the metal film intermediate layer MML. Also in case of the five-layered film which uses Mo, the etching speeds of Mo and Cu are sufficiently fast compared to an etching speed of the Al—Nd alloy and hence, it is possible to selectively etch only the three-layered laminated film made of Mo and Cu. In etching Cu, besides the above-mentioned aqueous solution, an ammonium persulfate aqueous solution, a sodium persulfate aqueous solution can be effectively used.

Subsequently, the metal film lower layer MDL is formed in a stripe shape in which the metal film lower layer MDL intersects the lower electrode DED by performing the patterning of resist by screen printing and etching. The etching is performed by wet etching using a mixed aqueous solution of phosphoric acid and acetic acid. Here, by displacing the position of the printing resist film in the direction parallel to the stripe electrode of the metal film upper layer MAL, one side EG1 of the metal film lower layer MDL projects from the metal film upper layer MAL thus forming a contact portion to ensure the connection with the upper electrode AED in a later stage and, on another side EG2 of the metal film lower layer MDL opposite to the above-mentioned one side EG1, using the metal film upper layer MAL and the metal film intermediate layer MML as masks, the over-etching is performed and hence, a retracting portion is formed on the metal film intermediate layer MML as if eaves are formed.

Due to the eaves of the metal film intermediate layer MML, the upper electrode AED which is formed as a film in a later step is separated. Here, since the film thickness of the metal film upper layer MAL is set larger than the film thickness of the metal film lower layer MDL and hence, even when the etching of the metal film lower layer MDL is finished, it is possible to allow the metal film upper layer MAL to remain on Cu of the metal film intermediate layer MML. Due to such a constitution, it is possible to protect a surface of Cu with the metal film upper layer MAL and hence, it is possible to ensure the oxidation resistance even when Cu is used. Further, it is possible to separate the upper electrode AED in a self-aligning manner and it is possible to form the upper bus electrodes which constitute scanning signal lines which perform the supply of electricity. Further, in case that the metal film intermediate layer MML is formed of the five-layered film which sandwiches Cu with Mo, even when the Al alloy of the metal film upper layer MAL is thin, Mo suppresses the oxidation of Cu and hence, it is unnecessary to make the film thickness of the metal film upper layer MAL larger than the film thickness of the metal film lower layer MDL.

Subsequently, electron emission portions are formed as openings in the interlayer film INS3. The electron emission portion is formed in a portion of an intersecting portion of a space which is sandwiched by one lower electrode DED inside the pixel and two upper bus electrodes (a laminated film consisting of metal film lower layer MDL, metal film intermediate layer MML, metal film upper layer MAL, a laminated film consisting of metal film lower layer MDL, a metal film intermediate layer MML, and a metal film upper layer MAL of neighboring pixel not shown in the drawing) which intersect the lower electrode DED. The etching is performed by dryetching which uses an etching gas containing CF₄ and SF₆ as main components, for example.

Finally, the upper electrode AED is formed as a film. The upper electrode AED is formed by a sputtering method. The upper electrode AED may be made of Al or a laminated film made of iridium (Ir), platinum (Pt) and gold (Au), wherein the film thickness is set to approximately 6 nm, for example. Here, the upper electrode AED is, at one end portion (right side in FIG. 6C) of two pieces of upper bus electrodes which sandwich the electron emission portion (a laminated film consisting of a metal film lower layer MDL, a metal film intermediate layer MML and a metal film upper layer MAL), cut by a retracting portion (EG2) of the metal film lower layer MDL formed by the eaves structure of the metal film intermediate layer MML and the metal film upper layer MAL. Then, at another end portion (left side in FIG. 6C) of the upper bus electrodes, the upper electrode AED is formed and is connected with the upper bus electrode (the laminated film consisting of the metal film lower layer MDL, the metal film intermediate layer MML and the metal film upper layer MAL) by a contact portion (EG1) of the metal film lower layer MDL without causing a disconnection thus providing the structure which supplies electricity to the electron emission portions.

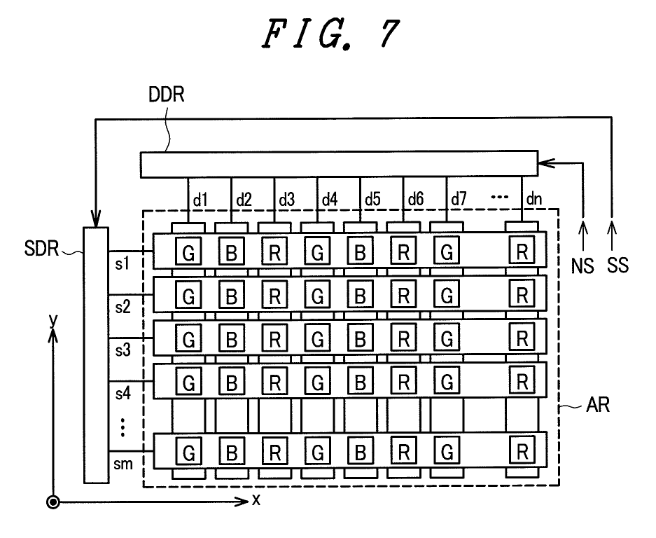

Next, FIG. 7 is an explanatory view of an example of an equivalent circuit of an image display device to which the constitution of the present invention is applied. A region depicted by a broken line in FIG. 7 indicates a display region AR. In the display region AR, pixels which are arranged in a matrix array are formed. Sub pixels are formed over the respective intersecting portions of the matrix and one group consisting of three unit pixels (or sub pixels) “R”, “G”, “B” in the drawing constitutes one color pixel. Here, the constitution of the electron sources is omitted from the drawing. The image signal lines (cathode lines) 8 are connected to the image signal drive circuit DDR through the image signal line lead terminals, while the scanning signal lines (gate lines) 9 are connected to the scanning signal drive circuit SDR through the scanning signal line lead terminal. The image signal NS is inputted to the image signal drive circuit DDR from an external signal source, while the scanning signal SS is inputted to the scanning signal drive circuit SDR in the same manner.

Due to such a constitution, by supplying the image signal to the image signal lines 8 which intersect the scanning signal lines 9 which are sequentially selected, it is possible to perform a two-dimensional full color image display. With the use of the display panel having this constitution, it is possible to realize the image display device at a relatively low voltage with high efficiency.

Here, in the above-mentioned embodiments, the explanation has been made with respect to the case in which the present invention is applied to the display device which uses the face substrate having the phosphor layers and the black matrix on the inner surface thereof and forming the metal back film (anode electrode) on the back surfaces of the phosphor layers and the back matrix film. However, the present invention is not limited to such a display device.

What is claimed is:

1. An image display device comprising:
a face substrate which includes phosphor layers and an anode electrode;
a back substrate which includes electron sources and faces the face substrate in an opposed manner with a predetermined distance therebetween;
a frame body which is interposed between the face substrate and the back substrate and is arranged so as to surround an image display region, and holds the predetermined distance between the substrates; and
a plurality of distance holding members which is arranged in the inside of the display region between the face substrate and the back substrate;
a conductive adhesive material which fixes end surfaces of the distance holding members with the face substrate and the back substrate respectively, wherein
the end surfaces of the frame body and the face substrate and the back substrate being hermetically sealed to each other respectively by way of a sealing material,
the distance holding members are jointed to both substrates in a state that the distance holding members bite into the conductive adhesive material in the depth direction of coating thickness of the conductive adhesive material.

2. An image display device according to claim 1, wherein the conductive adhesive material contains a conductive material which imparts conductivity to the adhesive material.

3. An image display device according to claim 1 or claim 2, wherein a width of the conductive adhesive material is set larger than a width of the distance holding member.

4. An image display device according to claim 3, wherein the width of the conductive adhesive material is set at least twice or more as large as the width of the distance holding member.

5. An image display device according to claim 1, wherein the distance holding member is made of a ceramic material and has a total length of 200 mm or less.

6. An image display device according to claim 1, wherein the distance holding member possesses a resistance value of 10 to 10⁹ Ω·cm.

7. An image display device according to claim 1, wherein the back substrate includes,
a plurality of scanning signal lines which extend in one direction and are arranged in parallel to another direction which intersects one direction,
a plurality of image signal lines which extend in another direction and are arranged in parallel in one direction,
the electron sources which are arranged in the vicinity of respective intersecting portions of the scanning signal lines and the image signal lines, and
power supply electrodes which connect the electron sources, the scanning signal lines and the image signal lines respectively.

8. An image display device according to claim 7, wherein the distance holding members are arranged in a state that the distance holding members are overlapped to the scanning signal lines and extend in the same direction as the scanning signal lines.

9. An image display device comprising:
a face substrate which forms a black matrix film in which a plurality of opening portions are formed, phosphor layers having a plurality of colors which are arranged in a state that the phosphor layers close the opening portions and extend over the black matrix film, and an anode electrode which is made of a metal thin film and covers the phosphor layers and the black matrix film on an inner surface thereof;
a back substrate which forms a plurality of scanning signal lines which extend in one direction and are arranged in parallel to another direction which intersects one direction, a plurality of image signal lines which extend in another direction and are arranged in parallel to one direction, and electron sources which are provided in the vicinity of respective intersecting portions of the scanning signal lines and the image signal lines on an inner surface thereof, and faces the face substrate in an opposed manner with a predetermined distance therebetween;
a frame body which is interposed between the face substrate and the back substrate in a state that the support body surrounds a display region and holds the predetermined distance;
a plurality of distance holding members which are arranged to be overlapped to the scanning signal lines and extend in the same direction as the scanning signal lines between the face substrate and the back substrate and within the display region; and
a conductive adhesive material which fixes end surfaces of the distance holding members and the face substrate and the back substrate to each other by adhesion,
the end surfaces of the frame body and the face substrate and the back substrate being hermetically sealed to each other by way of a sealing material, wherein
the distance holding members are jointed to both substrates in a state that the distance holding members bite into the conductive adhesive material in the depth direction of coating thickness of the conductive adhesive material.

10. An image display device according to claim 9, wherein the distance holding members are arranged in a state that the distance holding members are overlapped to the scanning signal lines and extend in the same direction as the scanning signal lines.
